(19) United States
(12) Patent Application Publication
(10) Pub. No.: US 2002/0165906 A1
(43) Pub. Date: Nov. 7, 2002

(54) Method and system for computer personalization

(76) Inventors: Glenn Ricart, Salt Lake City, UT (US); Carlos Soto, Morganhill, CA (US)

Correspondence Address: KAPLAN & GILMAN , L.L.P., 900NROUTE 9 NORTH, WOODBRIDGE, NJ, 07095, US

(21) Appl. No.: 09/769,605

(22) Filed: Jan. 25, 2001

Related U.S. Application Data
(60) Provisional application No. 60/232,369, filed on Sep. 14, 2000.

(51) Int. Cl. G06F 15/16

(52) U.S. Cl. 709/203

(57) ABSTRACT

A method and system for efficiently personalizing computer hardware. Under the present invention, a subscriber will store computer personalization information pertaining to their existing servers and workstations with a provider. As the servers and/or workstations are replaced (or upgraded), the personalization information can be transmitted/downloaded from the provider to the new (or upgraded) servers. Once the new severs are personalized, the personalization information pertaining to the old workstations will be sent/transmitted to the new workstations. This transmitted information will be then used to personalize the new workstations.

### RELATED APPLICATION

This application claims priority to Provisional No. 60/232,369 filed on Sep. 14, 2000.

### BACKGROUND OF THE INVENTION

1. Technical Field

The present invention relates to computer personalization, e.g., tools and techniques for rapidly and automatically personalizing generic server and workstation computers. More specifically, the present invention provides a system and method for automatically personalizing generic servers and workstations from a remote location.

2. Background Art

As the use of computers and computer networks becomes more prevalent, the demand for the capability to accurately and efficiently personalize servers and workstations increases. Specifically, as computer hardware is replaced or networks are upgraded, the new components need to be personalized to appear and function in the same manner as the replaced components.

In the present context, “personalizing” means installing or restoring data such as software settings, options, preferences, paths, directories, files, printers, wallpaper, favorites, styles, certificates, policies, software programs, trusts, domain privileges, security codes, defaults, and/or startup groups to a server and/or workstation so that the server and/or workstation will function like a previous one or otherwise be tailored to a particular user and/or particular subscriber. Examples of “personalization information” include:

“Roles Info”, namely, personalization information common to or driven by roles or functions within a company, such as password change policies;

“Net Info”, namely, personalization information common to a workgroup, network, or server, such as printers to be configured;

“Workstation Info”, namely, personalization information specific to a workstation, such as software programs to be loaded; and

“User Info”, namely, personalization information specific to a user, such as preferred default stylesheets.

Conventionally, computer personalization is performed by the user or a corporate administrator or system administrator over time. The administrator may add printers, change defaults, set up options, retrieve and save clip art, define an active directory hierarchy, and the like. Each of these actions changes the state of a computer workstation and/or a server and is saved in files such as registries, on the server, on the network, or in other places.

Heretofore, some efforts have been made to collect and transfer at least some of these many types/pieces of personalization information. For instance, published PCT patent application no. PCT/US99/30236 discusses automatic and selective transfer of software and configuration information. In addition, web pages at miramarsys.com discuss a utility for migrating applications, settings, and files.

Web pages at novell.com discuss ZENworks™ software of at least two kinds, namely, one for servers and one for desktops. ZENworks for Servers™ allows automated distribution of two kinds of data to servers, namely, “data files” and “SSPs.” Data files can be any file, including application documents, support files, policies, drivers, etc. An SSP can be any server application, such as a utility or a user application hosted on a server. ZENworks for Servers™ software apparently focuses on the problem of distributing various data to servers, rather than the problem of identifying personalization information to be distributed or the problem of personalizing both clients and servers in a network.

ZENworks for Desktops 2™ software uses Novell Directory Services™ software to deliver a user-specific configuration when the user logs in. Desktop policies, profiles, printers, and applications based on the user's needs and preferences are stored in the directory service software so that users see the same desktop regardless of which machine they log in from. Thus, ZENworks for Desktops 2™ software apparently does not permanently personalize the user's workstation; instead, it re-applies certain settings at login. Accordingly, ZENworks for Desktops 2™ software requires a network connection to operate. ZENworks™ and Novell Directory Services™ are trademarks marks of Novell™, Inc.

Microsoft's™ roaming profiles system apparently stores particular user preferences on network servers so that they can be re-applied at login time. However, the roaming profiles system apparently does not personalize the server and/or workstation with this information in a way that survives subsequent reboots or logins. Instead, the user preferences are retrieved on each login from the network and are not necessarily kept on the workstation after the session which started with that login ends.

Accordingly, there is a need for more systematic and efficient ways of performing network personalization using the kinds of personalization information listed above. The present invention provides tools and techniques for a subscriber to personalize their servers and workstations with all types of personalization information obtained from a remote provider. In addition, the present invention stores the personalization on the personalized servers and workstations in a durable way so that the personalization information need not be re-obtained from a remote network upon re-boot or login. This means that the personalization information is present even when there is no network connection between the subscriber and the provider.

### SUMMARY OF THE INVENTION

The present invention provides a method and system for a subscriber to efficiently personalize their servers and workstations (hardware) using personalization information obtained from a remote provider. Specifically, the present invention provides methods and systems for personalization information pertaining to a subscriber's existing hardware to be gathered and stored with the provider. The existing hardware can be replaced with new “generic” hardware. Upon replacement, the new generic hardware will be “personalized” when the stored information is transferred to the new hardware. This allows the new hardware to appear and function in the same manner as the old hardware.

According to a first aspect of the present invention, a method for personalizing a computer network is provided. The method comprises the steps of: (1) sending a generic server computer personalization information for personalizing the server; and (2) sending the server personalization information for personalizing at least one client of the server.

According to a second aspect of the present invention, a system is provided. The system comprises at least one server and at least one client, the server configured to receive server personalization information for personalizing the server and client personalization information for personalizing the client, the server also configured to provide the client personalization information to the client after the server is at least partially personalized by the server personalization information, the client configured to personalize itself using the client personalization information.

According to a third aspect of the present invention, a method for personalizing computer hardware is provided. The method comprises the steps of: (1) collecting and storing personalization information pertaining to an existing server and an existing client; (2) replacing the existing server and client with a new server and client; (3) sending the personalization information to the new server; (4) personalizing the new server using the personalization information pertaining to the existing server; (5) sending the personalization information pertaining to the existing client from the new server to the new client; and (6) personalizing the new client using the personalization information sent to the new client.

The above and other details and objects of the invention will become clearer upon review of the following drawings and detailed description of the preferred embodiment.

### BRIEF DESCRIPTION OF THE DRAWINGS

FIG. 1 is a first computer architectural diagram of a personalization provider and subscriber, according to the present invention;

FIG. 2 is a second computer architectural diagram of a personalization provider and a subscriber, according to the present invention; and

FIG. 3 is a method flow chart, according to the present invention.

It is noted that the drawing of the invention is not necessarily to scale. The drawing is merely a schematic representation, not intended to portray specific parameters of the invention. The drawing is intended to depict only one typical embodiment of the invention, and therefore should not be considered as limiting the scope of the invention. In the drawing, like numbering represents like elements.

### DETAILED DESCRIPTION OF THE DRAWINGS

As indicated above, the present invention provides a method and system for efficiently personalizing computer hardware. Specifically, under the present invention a subscriber will store computer personalization information pertaining to their existing servers and workstations with a provider. As the servers and/or workstations are replaced (or upgraded), the personalization information can be transmitted/downloaded from the provider to the new (or upgraded) servers. Once the new severs are personalized, the personalization information pertaining to the old workstations will be sent/transmitted to the new workstations. This transmitted information will be used to personalize the new workstations. Thus, the servers will be personalized first and then the workstations. Such tools and techniques are particularly useful in networks which are supported by subscription computing, but the invention is also useful in other networks. In a subscription computing environment (at least for purposes of the present invention), a subscriber obtains Internet access services, backup services, network maintenance services, and/or other computer networking services from a service provider. In a preferred embodiment, the subscriber and provider are different legal entities and thus, the provider is remote (i.e., at a remote location).

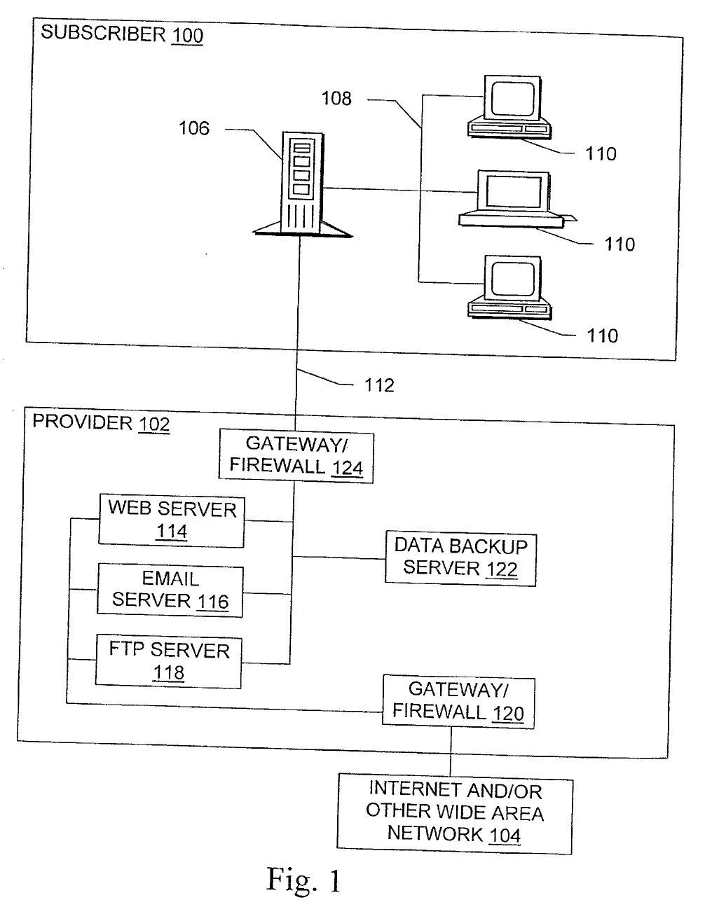

One of the many possible subscription computing architectures suitable for operation according to the present invention is illustrated in FIG. 1. As depicted, a subscriber 100 subscribes to services provided by a provider 102. These services may include Internet 104 access services like those provided by conventional ISPs, data backup services, local network maintenance services, and/or other networking services. The illustrated subscriber 100 has a computing infrastructure that includes a LAN server 106 connected by wireless or other network connections in a network 108 to one or more workstations 110. Suitable network clients 110 and individual computers include, without limitation, personal computers, laptops, and dumb terminals. The network 108 signal lines may include twisted pair, coaxial, or optical fiber cables, telephone lines, satellites, microwave relays, modulated AC power lines, infrared, RF or other wireless connections, and other data transmission “wires” known to those of skill in the art. Signals according to the invention may be embodied in such “wires” and/or in addressable storage media such as the server 106 disk or RAM.

The subscriber server 106 is connected to the provider 102 by a DSL or other data communications link 112. The provider 102 uses various access servers to provide the subscriber 100 with access services over the link 112. For instance, the illustrated provider 102 has access servers that include a web server 114, an email server 116, and an FTP server 118. A data backup server 122 can backup information for the subscriber 100. Other providers 102 may have more, fewer, and/or different access servers or data backup mechanisms. The servers 106, 114-118 may be uniprocessor or multiprocessor machines, and/or may include a tightly coupled cluster of machines. The servers 106, 114-118 may have storage in the form of internal disks, external disks, and/or Redundant Array of Independent Disks (“RAID”) units.

The provider 102 can include, for instance, an Internet Service Provider (ISP); a corporate IS department; one or more departmental server(s); one or more residential access gateway(s) or server(s); one or more small or medium size business gateways or servers; one or more aggregation and service points for a “smart” house, networked automobile, networked airplane, and so on; an application service provider (ASP); a network and desktop outsourcing service (NDOS); a commercial building main distribution room (MDF) and/or server(s) shared by tenants; a co-location provider (“co-lo” facility); a server installed at an aggregation point in a network specifically to implement the present invention; and/or a fixed or anchor machine(s) to which a person refers using smaller, possibly wireless, access devices.

On behalf of one or more network clients 10 and/or the subscriber server 106, data is transferred between the subscriber server 106 and the various access servers (e.g., servers 114, 116, 118), through zero or more gateways and/or firewalls such as those identified as components 120, 124, and the Internet 104 and/or other site(s) with which the provider site 102 communicates. Gateways and firewalls 120, 124 are for illustration only; some embodiments have more, fewer, or different gateways, firewalls, bridges, routers, etc, than shown.

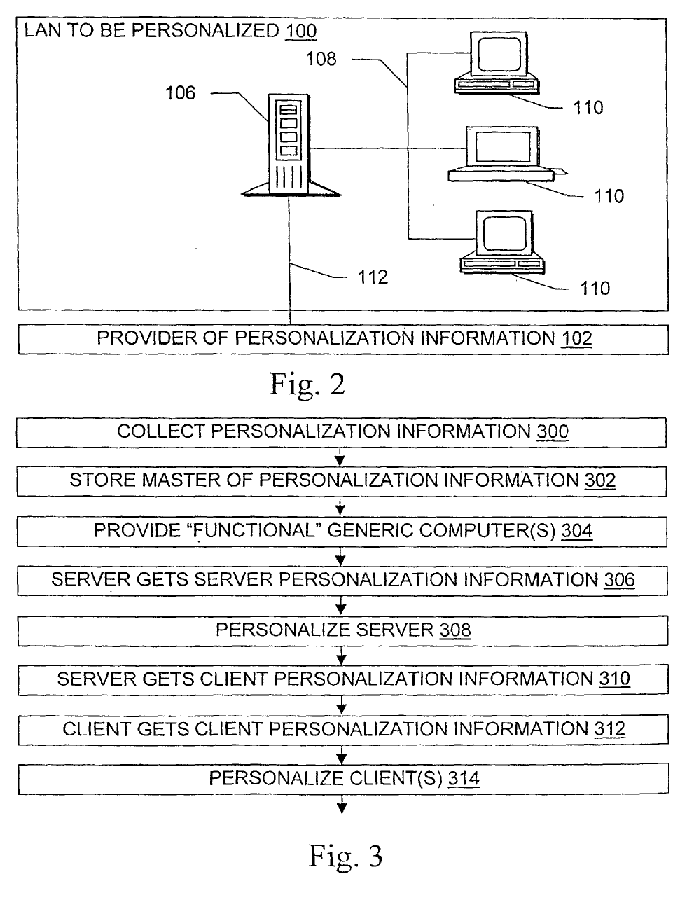

As illustrated by FIG. 2, the present invention may also be used in architectures in which the LAN 108 is not necessarily a subscription computing LAN and the provider 102 does not necessarily provide subscription computing services such as ongoing Internet access.

The invention may be used to initially configure a network such as the illustrated LAN 108. The invention may also be used to reconfigure a network server such as server 106 and/or a client 110 after a hardware upgrade or replacement. Initial configuration of a new network at a subscriber site will be used as the primary example, but those of skill will readily apply these inventive teachings to facilitate the configuration of upgrade or replacement computers, and to do so regardless of whether the provider 102 of personalization information also provides subscription computing services.

Turning now to the example of initial configuration of a subscription computing network, the subscription computing service provider 102 (or an agent or partner thereof) ships a generic server 106 and generic workstations 110 to the customer site 100. Use of generically constructed and configured machines 106, 110 simplifies inventories, and simplifies subsequent maintenance. But merely supplying generic computers often fails to meet the needs or preferences of a particular subscriber 100. Accordingly, when the generic computers arrive at the subscriber, the invention facilitates reconfiguring those computers to take on the “personality” of that particular customer and the customer's users, and doing so automatically and efficiently. Embodiments of the invention provide a multi-tier process which can be used by businesses to convert generic computers to highly personalized computers.

The present invention may be used to personalize systems in various situations. For instance, the invention may be used when a server 106 or workstation 110 fails, is lost, or is stolen and is to be replaced by another computer which should then appear to the user or system administrator to function nearly identically with the former computer. Alternately, a server 106 or workstation 110 may become obsolete and need to be replaced by another computer of a newer model or software version, which should be personalized to appear to the user or system administrator to function nearly identically, at least with respect to personal preferences, access to network devices, and compliance with corporate policies. Personalization may also occur when versions of the operating system or other major components must be upgraded, when migrating from one corporate system to another (as during a merger of two companies), and when moving to more secure systems from less secure systems. Of course, these are merely examples; the invention may also be used to personalize systems in other situations.

FIG. 3 illustrates methods of the invention. It accordingly also illustrates other embodiments, such as computer-readable storage media or computer systems which are configured to operate according to these methods.

During a collecting step 300, personalization information, such as information of the four types discussed herein, is collected. Conventional tools and techniques can be used to gather at least some of the information, such as tools and techniques employed by commercially available tools for migrating configuration information between computer workstations.

During a master storing step 302, a master copy of the collected personalization information is stored. The master copy may be stored at a service provider's datacenter 102. In addition or alternately, the master copy may be stored on a host computer 106, on legacy computers 106/110 which are being replaced, and/or on removable media using storage mechanisms such as lomega Zip or Jaz drives or the like.

During a computer providing step 304, “functional” generic computers 106/110 are provided at the site 100 of a LAN or other network 108 which is being configured with the invention. In some embodiments, the subscriber 100 has a set of computer workgroups comprising a LAN 108, connectivity 112 from that LAN to a corporate or service provider datacenter 102, one or more servers 106 connected to the LAN 108, and one or more workstations 110 connected to the LAN.

The server(s) and/or client workstation(s) of the network 108 being configured are “functional” in the sense that basic software such as the operating system and basic network connectivity software and information (e.g., local network addresses) is already present on them. Conventional tools and techniques for loading operating systems and distinguishing them with unique network names and/or addresses may be used. In this sense, the target system is functional and connected, but it is not yet personalized. In a preferred embodiment, the server(s) and/or client workstation(s) are configured to appear to be non-functional until their personalization information is downloaded and installed, despite the fact that they have a functional operating system and could possibly be used in a non-personalized mode.

Note that the steps of the invention may be performed in an order different from that shown in the Figure, except to the extent that one step requires the result of another step. For instance, the generic computers may be provided 304 before the personalization information is collected 300. Steps may likewise be overlapped or interleaved, as when some of the personalization information is collected 300 and then stored 302, after which additional personalization information is collected 300 and stored 302.

During a server personalization information obtaining step 306, the server 106 of the network being configured gets at least its own personalization information. This includes Net Info which will be used to personalize the current server 106. In some embodiments, servers 106 are configured so that when they are first turned on at the site 100, they query the datacenter 102 for all four types of personalization information, for themselves and their clients. In other embodiments they initially query only for their own personalization information.

Although generic servers 106 have a functional operating system and could possibly be used in a non-personalized mode, they are preferably configured to appear to be non-functional until the personalization information is downloaded over communications link 112 from datacenter 102. Roles Info, Workstation Info, and User Info personalization information is stored by the server 106 for later use, while Net Info information is used to personalize 308 the current server. An alternative method retrieves only Net Info and that portion of the Roles Info that applies to the server 106 at this time, and/or retrieves personalization information incrementally as it is actually needed.

During the server personalizing step 308, the Net Info often changes the server's name, the domain in which it resides, the list of services it should provide, the way its disks should be configured (e.g. striped, RAID, mirrored, etc.) and/or its Internet address (IP address). In some cases it changes all of these. If necessary, the server 106 reboots so that it comes back up as a network server and advertises its new (if changed) name, IP address, domain, etc. In one embodiment, the server 106 reboots several times as various stages of this Net Info personalization continue. Then, Roles Info that applies to the server is integrated into the server 106. This often changes policies, establishes trusts to other corporate domains, and so on.

Optionally, during a step 310 the server 106 now receives Workstation Info, User Info, and Roles Info personalization information that applies to workstations 110. In an alternative embodiment, all the personalization information for the server 106 and for the clients 110 was sent together to the server 106, in that step 310 was merged into step 306.

In connection with a client personalization information obtaining step 312, the server(s) 106 turn on services that listen, in turn, to requests from workstations 110 for Roles Info, Workstation Info, and User Info personalization information. Up until now, workstations 110 requesting personalization information of their own have been ignored by the server 106.

The tiered nature of this personalization mechanism, in which the server 106 is personalized 308 and then the server 106 assists in personalizing its clients 110, is an important part of the present invention. I n a subscription computing environment, all of the server 106 personalization is done the first time the server 106 successfully connects to the datacenter 102 and all of the workstation 110 personalization is done the first time the workstation 110 successfully connects to the server 106. It is not necessary to re-perform personalization on each login. Nor does personalization require having the server 106 continually connected to the datacenter 102 or having the workstation 110 continually connected to the server 106; personalization can be performed without a live network connection.

By moving the personalization information to the server(s) 106 first and then to their respective client(s) 110, several efficiencies are gained. For instance, the link 112 connecting the network 108 to the datacenter 102 only needs to be used once to communicate any given personalization information. Repetitive information that applies to multiple workstations 110 is sent only once, saving time and reducing cost. Also, the workload on the datacenter 102 is greatly reduced, allowing a large corporate process of re-personalization to proceed scalably and rapidly. In addition, it is easier to ensure that a consistent set of Roles Info personalization information is sent to each workstation 110 even if there are changes in this information at the datacenter 102 during personalization. Finally, if the workstations 110 will depend on services provided by the server(s) 106, these services will have been properly personalized at the server 106 so they are ready for use.

As noted, workstations 110 using the process described herein are preferably already “functional” in that they have a working operating system and network connection, but are configured to do little or nothing in response to user requests until they receive their personalization information. Instead, the clients 110 periodically query their server(s) 106, waiting for the end of the server portion of the personalization process.

During step 312, the client 110 of the network 108 being configured gets its own personalization information. Each client 110 being configured receives that portion of the Roles Info, Workstation Info, and User Info personalization information that applies to it.

Clients 110 then apply this information during a client personalizing step 314. For instance, clients 110 may join themselves to domains, retrieve copies of corporate software, and/or retrieve copies of software designed for specific workstations, such as those in the accounting department. User Info personalization information is typically stored in user-specific places, such as Microsoft's “Documents and Settings” directory for each user. Workstation Info personalization information is typically stored in system-specific places, such as the registry under Windows operating systems. Corporate Roles Info information may applied last, to ensure implementation of corporate policies.

It will be appreciated that several additional variations of the invention are also possible. For example, the network being configured may have more than two tiers, as occurs for instance in a network which has higher-tier location servers, department servers which are served by the location server, and workstations that are served directly by the department servers.

As another variation, the server(s) may retrieve personalization information as needed instead of getting it all-at-once; the servers preferably retrieve each piece of information only once and re-distribute it from the most local tier as needed.

In addition to initial setup, the invention can be used to re-personalize individual servers or workstations that have been replaced by those having a generic image.

Also, corporate Roles Info can be subservient to Workstation Info and/or Use Info, namely, it can be applied only when it is not overridden by them, instead of dominating them so that company policies apply regardless of contrary preferences in the Workstation Info and/or User Info.

Of course, these and other alternatives may also be combined to form additional variations on the invention.

In general, however, the invention in its various forms can provide advantages such as speed and efficiency of personalization by using the tiering mechanism described herein; the ability to ship a generic server and/or workstation to each customer and let these generic computers automatically personalize themselves to the particular customer in question; and attention to all types of personalization information in a network, not just one or two types.

Moreover, personalization performed according to the invention is durable and does not depend on working network connections at the time of login. Therefore, this inventive approach to computer personalization works well even for laptops, wireless devices, and other traveling systems. For instance, a laptop may be personalized on an airplane and then used there without forming any communications link to a network or another computer.

Although particular systems and methods embodying the present invention are expressly illustrated and described herein, it will be appreciated that apparatus, signal, and article embodiments may also be formed according the present invention. Unless otherwise expressly indicated, the description herein of any type of embodiment of the present invention therefore extends to other types of embodiments in a manner understood by those of skill in the art.

The invention may be embodied in other specific forms without departing from its essential characteristics. The described embodiments are to be considered in all respects only as illustrative and not restrictive. All changes come within the meaning and range of equivalency of the claims are to be embraced within their scope.

1. A method for personalizing a computer network, comprising the steps of:
sending a generic server computer personalization information for personalizing the server; and
sending the server personalization information for personalizing at least one client of the server.

2. The method of claim 1, wherein the step of sending information for personalizing the server comprises sending at least one of: the server's name, the domain in which it resides, the list of services it should provide, the way its disks should be configured (e.g. striped, RAID, mirrored, etc.) or its Internet address (IP address).

3. The method of claim 1, wherein the step of sending information for personalizing at least one client comprises sending at least one of: identification of a “Documents and Settings” directory for a user, Windows operating system registry information, and corporate policy information.

4. The method of claim 1, further comprising the step of configuring the server to ignore workstation requests for personalization until after the server is at least partially personalized.

5. The method of claim 1, further comprising the step of configuring the client to ignore at least some user requests until after the client is at least partially personalized.

6. A configured storage medium embodying data and instructions readable by a computer to perform the method of claim 1.

7. A system comprising at least one server and at least one client, the server configured to receive server personalization information for personalizing the server and client personalization information for personalizing the client, the server also configured to provide the client personalization information to the client after the server is at least partially personalized by the server personalization information, the client configured to personalize itself using the client personalization information.

8. The system of claim 7, wherein at least one client is a laptop disconnectable from the server.

9. The system of claim 7, further comprising a higher-tier server, such that the higher-tier server receives personalization information for personalizing the client's server, and the higher-tier server provides such personalization information to the client's server after the higher-tier server receives higher-tier server personalization information and at last least partially personalizes itself using that information.

10. The system of claim 7, wherein corporate Roles Info personalization information is subservient to Workstation Info and/or User Info.

11. The system of claim 7, wherein corporate Roles Info personalization information dominates Workstation Info and/or User Info.

12. A method for personalizing computer hardware, comprising the steps of:
collecting and storing personalization information pertaining to an existing server and an existing client;
replacing the existing server and client with a new server and client;
sending the personalization information to the new server;
personalizing the new server using the personalization information that pertains to the existing server;
sending the personalization information that pertains to the existing client from the new server to the new client; and
personalizing the new client using the personalization information sent to the new client.

13. The method of claim 12, wherein the personalization information is stored with a remote service provider.

14. The method of claim 12, wherein the personalization information comprises roles information, net information, client information, and user information.

15. The method of claim 14, wherein role information comprises personalization information common to or driven by roles or functions within a company, wherein net information comprises personalization information common to a workgroup, network, or server, wherein client information comprises personalization information specific to a client, and wherein user information comprises personalization information specific to a user.

16. The method of claim 12, wherein the new client and server are generic.
